(19) United States
(12) Patent Application Publication
(10) Pub. No.: US 2024/0243490 A1
(43) Pub. Date: Jul. 18, 2024

(54) PLUG CONNECTOR HAVING A BRIDGING FUNCTION

(71) Applicant: HARTING ELECTRIC STIFTUNG & CO. KG, Espelkamp (DE)

(72) Inventor: Markus WITTPAHL, Hüllhorst (DE)

(21) Appl. No.: 18/563,586

(22) PCT Filed: May 13, 2022
(86) PCT No.: PCT/DE2022/100360

§ 371 Date: Nov. 22, 2023

(30) Foreign Application Priority Data
May 26, 2021 (DE) 10 2021 113 555.9

(51) Int. Cl. H01R 4/60; H01R 4/18; H01R 13/11; H01R 13/415; H01R 13/506

(52) U.S. Cl. CPC H01R 4/60; H01R 4/183; H01R 13/111; H01R 13/415; H01R 13/506

(57) ABSTRACT

A plug connector is provided having a plug-in side, a connection side, and a plug-in direction, which extends from the connection side to the plug-in side, towards a mating connector or a socket, the plug connector having a contact insert and at least four contact elements, the contact elements being positioned in the contact insert in dedicated receiving regions, the plug connector having at least two bridging elements for the electrical connection of in each case at least two contact elements, the bridging elements being positioned one behind the other as viewed in the plug-in direction.

### BACKGROUND

### Technical Field

The present disclosure relates to a plug connector.

Such plug connectors are needed when the currents of individual conductors of a multi-strand cable must be distributed within the plug connector. This is the case in so-called data centers, for example. Here, the so-called neutral conductor of the connected cable must be distributed within a data rack to the individual server units of the data rack.

### Description of the Related Art

The document DE 20 2007 017 892 U1 discloses a contact insert for industrial plug connectors having a PE plate.

If it is necessary to bridge individual conductors for specific applications, the conductors have until now been bridged inside the plug connector housing. So-called conductor terminals, for example, are used for this. However, sufficient space must be present and a correspondingly sized housing must be selected for this. Bridging inside the housing entails a large hazard potential. If the mechanical connection of the bridged conductors does not hold, current-carrying conductors can reach the plug connector housing.

The German Patent and Trade Mark Office has searched the following prior art in the priority application for the present application: JPH09-306617 A, JPH10-3972 A, CN 104 701 692 A and U.S. Pat. No. 5,007,888 A.

### BRIEF SUMMARY

Embodiments of the present disclosure provide a plug connector that is safe, has a compact structure, and can be connected conveniently to a cable.

The plug connector described herein includes a plug-in side and a connection side. On the connection side, the individual conductors of a multi-strand cable are connected conductively to the respective contact elements arranged in receiving regions provided in a contact insert. The plug-in side of the plug connector is guided to a mating connector or a socket for electrical contacting. Accordingly, the plug-in direction or the plug-in direction vector of the plug connector runs from the connection side to the plug-in side.

The plug connector has at least four contact elements, which, as already described above, are arranged in receiving regions in the contact insert.

The plug connector has at least two bridging elements, which are provided for the electrical connection of at least two contact elements each. The bridging elements are arranged one behind the other as viewed in the plug-in direction (SR).

In some embodiments, the contact insert has at least two lateral recesses, into each of which a bridging element can be inserted or received. As a result, different bridging elements can be used, and the plug connector can be customized in terms of bridging technology.

In some embodiments, the bridging elements may be arranged parallel to one another and on different planes. If the plug-in direction is vertical to the viewer, the bridging elements are arranged one above the other to the viewer.

Advantageously, the contact elements each may have at least two grip regions for one bridging element each.

In some embodiments, the bridging element may have at least two gripping hands, which each fit around and electrically contact one contact element. The gripping hands each fit around a grip region of the contact element.

In at least one embodiment, a first bridging element fits around a grip region of a first contact element and a grip region of a second contact element. In this case, the grip regions of the first and second contact elements extend within a first plane (E1) parallel to the plug-in side. At the same time, a second bridging element fits around a grip region of a third contact element and a grip region of a fourth contact element. In this case, the grip regions of the third and fourth contact elements extend within a second plane (E2) parallel to the plug-in side. These planes (E1, E2) are parallel to one another and have a spacing (D) greater than zero. This means that the bridging elements are also parallel to one another and have a spacing, i.e., do not touch one another.

In some embodiments, the contact elements each may have a crimping region for electrical connection to a conductor. Crimping technology is very reliable and has advantages in particular in harsh industrial environments.

The geometric shape of the contact elements may be such that the contact elements each have, as viewed in the plug-in direction, a crimping region first, adjoined by a first grip region, which is adjoined by a second grip region. The crimping region is situated directly at the connection end of the contact element so that the plastic crimping deformations occurring here do not have any effects on the grip regions or on the bridging function.

In some embodiments, the plug connector may have a plug connector housing made of plastic. A lightweight design of the plug connector can be realized thereby. It is also advantageous if the plug connector housing and the contact insert are formed integrally together. The plug connector housing and the contact insert can be manufactured integrally in a single injection-molding process.

Advantageously, the plug connector has at least one snap-in means or device. With the aid of the snap-in means or device, the plug connector can be reversibly fastened lockably to a mating connector or a socket. Unintentional detachment of the plug connection is prevented thereby.

### BRIEF DESCRIPTION OF THE SEVERAL VIEWS OF THE DRAWINGS

Embodiments of the disclosure are shown in the drawings and will be explained in more detail below.

FIG. 1 shows a perspective diagram of an embodiment of a plug connector.

FIG. 2 shows a perspective sectional view of a portion of the plug connector without contact elements.

FIG. 3 shows a perspective sectional view of a portion of the plug connector with contact elements arranged therein.

FIG. 4 shows a partially cut away side view of a portion of the plug connector.

FIG. 5 shows a perspective sectional diagram of a contact insert of the plug connector.

FIG. 6 shows a perspective diagram of a contact element of the plug connector.

FIG. 7 shows a perspective diagram of an alternative embodiment of a contact element of the plug connector.

### DETAILED DESCRIPTION

The figures may contain in some cases simplified, schematic representations. Identical reference signs are sometimes used for similar but possibly non-identical, elements. Different views of similar elements might be scaled differently.

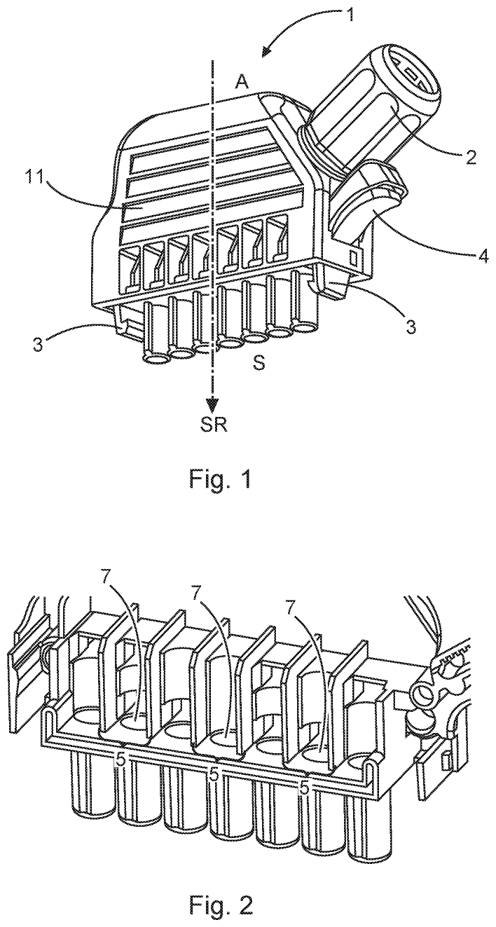

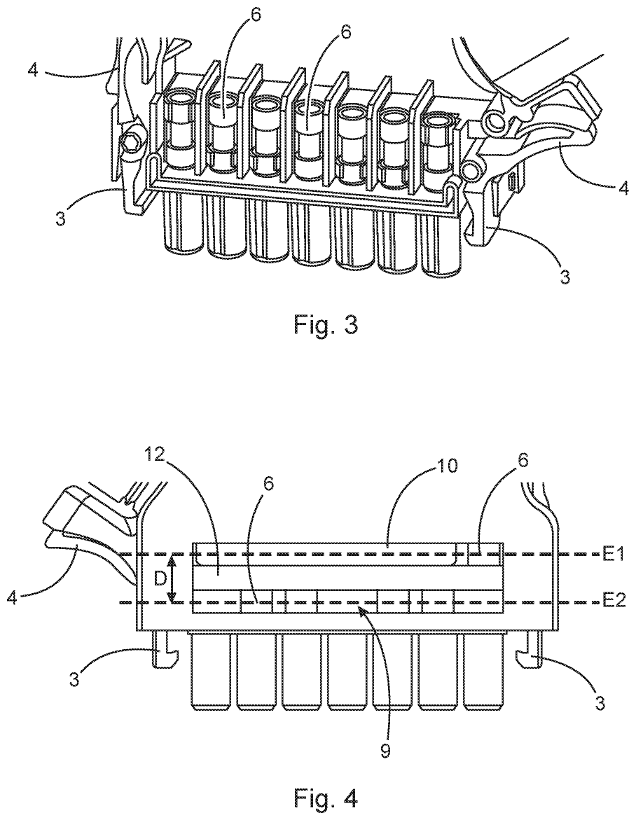

FIG. 1 shows a plug connector 1 according to an embodiment of the invention in a perspective diagram. The plug connector 1 has a rectangular cross section and is therefore also referred to as a rectangular plug connector. The plug connector 1 has a cable gland 2, which at the same time also forms a strain relief for a connected multi-strand cable (not shown).

The plug connector 1 has a connection side A, to which the cable or its conductors are connected, and a plug-in side S, which is guided in the plug-in direction SR to a mating connector or a socket (neither shown).

The plug connector 1 has locking hooks 3, which engage in snap-in openings provided therefor in a mating connector or a socket for reversible locking. The locking hooks 3 can correspondingly be detached again by an actuator 4 situated on the outside of the plug connector housing.

In FIG. 2, the plug connector 1 is shown partially cut away. As a result, the receiving regions 5 in which the contact elements 6, 6′ are arranged can be seen. In the receiving regions 5 there are openings 7 into which the contact elements 6, 6′ are inserted.

FIGS. 6 and 7 show embodiments of a contact element 6, 6′. The contact element 6, 6′ has a crimping region C for the attachment by crimping of the conductor to be connected. Furthermore, the contact element 6, 6′ has two grip regions Z1 and Z2 that can be gripped by the bridging element 10 for the electrical bridging of the contact elements 6, 6′.

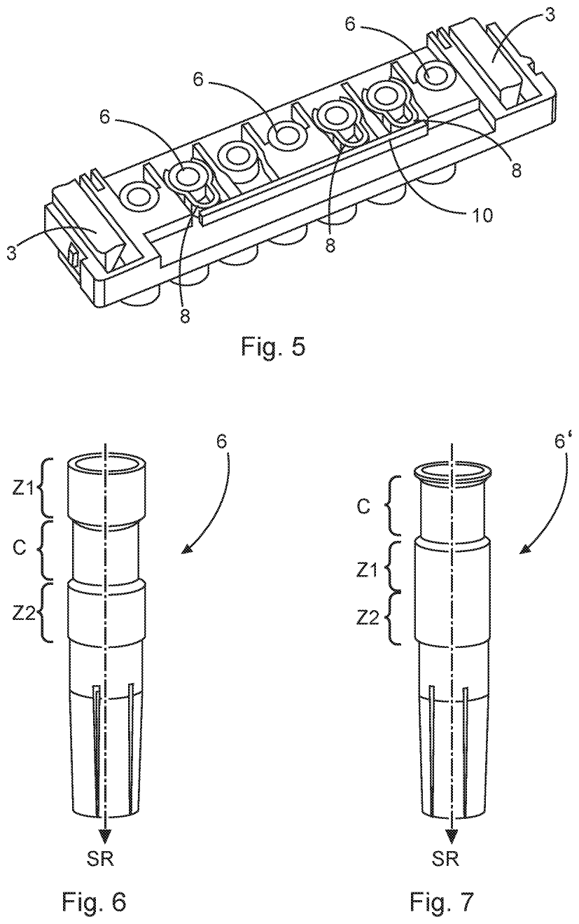

In FIG. 5, the operating principle of a bridging element 10 can be seen easily. The bridging element 10 comprises or consists of a conductive material. The bridging element 10 has a substantially elongate strip from which multiple gripping hands 8, exactly three in the case shown, project perpendicularly. The gripping hands 8 have substantially the same operating principle as a hand of a toy brick minifigure. The gripping hands 8 each surround the grip region Z1 or Z2 of the contact element 6, 6′ assigned thereto.

In FIG. 4, the plug connector 1 is shown with a partially cut away plug connector housing 11 so that the viewer can see the integrated contact insert 12. The contact insert 12 has two lateral recesses 9. The bridging element 10 can be inserted laterally into the contact insert 12 into these recesses 9. In the process, the gripping hands 8 of the bridging element 10 enclose or surround the contact elements 6, 6′ assigned thereto, as shown in FIG. 5. FIG. 4 shows only one bridging element 10, which is situated in a recess 9. The second recess 9 is kept free to show the viewer that it is possible to grip the contact elements 6, 6′ or the grip regions Z thereof through it.

In the embodiment of the plug connector 1 in FIG. 4, a cap (not shown) is attached after the insertion of the contact bridges in order to close the open region again so that it is not touchable or accessible from the outside.

In FIG. 4, it can be seen that the bridging elements 10, if two bridging elements 10 were shown here, are arranged parallel to one another and on different planes E1, E2.

FIG. 6 shows an embodiment of a contact element 6. As viewed in the plug-in direction SR, grip regions Z1, Z2 and crimping region C alternate.

Shown in FIG. 7 is an alternative embodiment of a contact element 6′. Viewed in the plug-in direction SR, the contact element 6′ has a crimping region C first, which is followed by two grip regions Z1, Z2 arranged one behind the other.

Even though various aspects or features of embodiments of the disclosure are each shown in combination in the figures, it is apparent to a person skilled in the art— unless otherwise indicated—that the combinations shown and discussed are not the only possible ones. In particular, corresponding units or feature combinations from different embodiments may be interchanged with each other. Put another way, aspects of the various embodiments described above can be combined to provide further embodiments.

In general, in the following claims, the terms used should not be construed to limit the claims to the specific embodiments disclosed in the specification and the claims, but should be construed to include all possible embodiments along with the full scope of equivalents to which such claims are entitled.

1. A plug connector, comprising:
a plug-in side,
a connection side, and
a plug-in direction running from the connection side to the plug-in side toward a mating connector or a socket,
wherein the plug connector includes a contact insert and at least four contact elements, wherein the contact elements are arranged in the contact insert in receiving regions, wherein the plug connector has at least two bridging elements for the electrical connection of at least two contact elements each, wherein the bridging elements are arranged one behind the other as viewed in the plug-in direction.

2. The plug connector according to claim 1, wherein the contact insert has at least two lateral recesses, into each of which a bridging element can be inserted and received.

3. The plug connector according to claim 1, wherein the bridging elements are arranged parallel to one another and on different planes.

4. The plug connector according to claim 1, wherein the contact elements each have at least two grip regions for one bridging element each.

5. The plug connector according to claim 1, wherein the bridging element has at least two gripping hands, which each fit around and electrically contact a respective contact element.

6. The plug connector according to claim 5, wherein the gripping hands each fit around a grip region of a contact element.

7. The plug connector according to claim 4, wherein:
a first bridging element fits around a grip region of a first contact element and a grip region of a second contact element, wherein the first grip regions of the first and second contact elements extend within a first plane parallel to the plug-in side, and
a second bridging element fits around a grip region of a third contact element and a grip region of a fourth contact element, wherein the grip regions of the third and fourth contact elements extend within a second plane parallel to the plug-in side,
wherein the first and second planes are parallel to one another and have a spacing that is greater than zero.

8. The plug connector according to claim 1, wherein the contact elements each have a crimping region for electrical connection to a respective conductor.

9. The plug connector according to claim 4, wherein the contact elements each have, as viewed in the plug-in direction, a crimping region first, adjoined by a first grip region of the at least two grip regions, which is adjoined by a second grip region of the at least two grip regions.

10. The plug connector according to claim 1, wherein the plug connector has a plug connector housing made of plastic.

11. The plug connector according to claim 10, wherein the plug connector housing and the contact insert are formed integrally together.

12. The plug connector according to claim 1, wherein the plug connector has at least one snap-in device with which the plug connector is reversibly lockable to the mating connector or the socket.
